(19) United States
(12) Patent Application Publication
(10) Pub. No.: US 2026/0365820 A1
(43) Pub. Date: Nov. 19, 2026

(54) ELASTOMER COMPOSITES PRODUCED FROM SUSTAINABLE FILLERS AND METHODS FOR MAKING AND USING THE SAME

(71) Applicant: The Goodyear tire & Rubber Company, Akron, OH (US)

(72) Inventors: Robert Vincent Dennis-Pelcher, Uniontown, OH (US); Kuo-Chih Hua, Richfield, OH (US); Liqing Ma, Uniontown, OH (US); Peter Isaac Dent, Akron, OH (US); Michael Lester Kerns, Medina, OH (US)

(21) Appl. No.: 19/575,191

(22) Filed: Mar. 23, 2026

Related U.S. Application Data
(60) Provisional application No. 63/778,495, filed on Mar. 27, 2025.

(51) Int. Cl. C08K 3/04; C08J 3/20; C09C 1/48

(52) U.S. Cl. CPC C08K 3/04; C08J 3/203; C09C 1/482; C01P 2004/61; C08K 2201/005

(57) ABSTRACT

In accordance with the purpose(s) of the present disclosure, as embodied and broadly described herein, are methods for producing elastomer composites in a sustainable manner. In one aspect, the elastomer composites include a carbon material derived from an end-of-life tire (ELT) uniformly dispersed in an elastomer. The elastomer composites described herein once vulcanized have comparable or improved performance properties when compared to elastomers prepared from traditional fillers and methods. The uncured elastomer composites described herein can be vulcanized to produce a variety of components used in the production of tires and other articles.

### BACKGROUND

Fillers such as carbon black are widely used to produce rubber compositions for the manufacture of tires and other articles. In the case of large-scale production, there is always a desire to use environmentally sustainable materials that will ultimately have little to no long-term impact on the environment. It is possible to decompose used tires (“end of life” tires or “ELTs”) to isolate organic and inorganic materials therefrom. One product obtained from decomposed tires can include carbon back. However, this carbon black is difficult to disperse in a polymer matrix due to its large particle size, high ash content, and disrupted surface chemistry. When selecting such materials, the chemical and physical properties of rubber compositions cannot be compromised, as the tire must achieve acceptable performance. Needed is an elastomer composite that provides good dispersion of sustainable carbon materials in a polymer matrix, while also displaying satisfactory performance properties when used in a rubber composition.

### SUMMARY

In accordance with the purpose(s) of the present disclosure, as embodied and broadly described herein, are methods for producing elastomer composites in a sustainable manner. In one aspect, the elastomer composites include a carbon material reclaimed from ELTs dispersed in an elastomer. The elastomer composites described herein, once vulcanized, have comparable or improved performance properties when compared to elastomers prepared from traditional fillers and methods. The vulcanized elastomer composites described herein can be components used in the production of tires and other articles.

Other composition, methods, features, and advantages of the present disclosure will be or become apparent to one with skill in the art upon examination of the detailed description. It is intended that all such additional compositions, methods, features, and advantages be included within this description, be within the scope of the present disclosure, and be protected by the accompanying claims. In addition, all optional and preferred features and modifications of the described embodiments are usable in all aspects of the disclosure taught herein.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a plasticizer” include, but are not limited to, mixtures or combinations of two or more such plasticizers, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, the term “phr” refers to parts by weight of a respective material per 100 parts by weight of rubber or elastomer. In general, using this convention, an elastomer composition is comprised of 100 parts by weight of rubber/elastomer. The claimed composition may comprise other rubbers/elastomers than explicitly mentioned in the claims, provided that the phr value of the claimed rubbers elastomers is in accordance with claimed phr ranges and the amount of all rubbers/elastomers in the composition results in total in 100 parts of rubber.

The terms “rubber” and “elastomer” may be used herein interchangeably, unless indicated otherwise.

As used herein, the term “uncured elastomer composite” refers to a composition including at least one natural or synthetic rubber component and, optionally, one or more fillers, processing aids, or additional ingredients, that has not been vulcanized. Uncured rubber is sensitive to changes in temperature and has a tendency to undergo “cold flow” (slow movement or deformation under stress) over time. In some aspects, the uncured rubber composition is a masterbatch.

As used herein, the term “vulcanized elastomer composite” refers to a rubber composition obtained by taking an uncured composition as described herein and curing or vulcanizing it, often accomplished using sulfur compounds and/or other curing additives and in the presence of heat. Vulcanized or cured rubber does not undergo cold flow and is less sensitive to changes in temperature relative to uncured rubber. In another aspect, rubber compositions can be cured in molds in order to form finished articles including, but not limited to, tires.

Unless otherwise specified, pressures referred to herein are based on atmospheric pressure (i.e. one atmosphere).

### Elastomer Composites and Methods for Producing the Same

Described herein are elastomer composites produced from sustainable materials. In one aspect, the elastomer composites include a reclaimed or recovered carbon black formed from recycled carbonaceous material (i.e., organic material that includes elemental carbon) from ELTs, also referred to as waste tires, and scrap rubber (hereinafter collectively referred to as “ELTs”). In other words, the elastomer composites comprise a carbonaceous material derived from ELTs. Although not limiting, “carbon black” is described hereafter as one exemplary carbonaceous material for illustrative purposes.

“Carbon black”, as used herein, refers to the generic term for the material produced by the incomplete combustion of heavy petroleum products (furnace process). Commercially available furnace carbon blacks are derived from the incomplete combustion of liquid hydrocarbons under controlled conditions. This method allows wide control over carbon black properties, such as particle size or structure. Examples of furnace carbon blacks include, inter alia, N110, N220, N330, N550, N660, N772 and blends thereof. In a tire, there are usually a number of different carbon blacks used, and sometimes in blends.

“Recovered carbon” (rC) and “recovered carbon black” (rCB), as used herein, mean carbon material recovered from ELTs by pyrolyzing or thermal demanufacturing the ELTs. Pyrolysis uses heat in the absence of oxygen to decompose the tire to yield a carbonaceous char material that is a solid recovered carbon co-product. The term “co-product” means that it may contain crystalline silica at relatively low levels compared to ground coal.

There is no limitation made herein to the method of pyrolyzing ELTs, but illustrative methods are described in, inter alia, U.S. Pat. Nos. 10,119,031B2 and 11,441,038B2 and one example rC is characterized in U.S. Pat. No. 12,012,497B2. Thermal decomposition, also referred to as thermal depolymerization or thermal demanufacturing, is distinguishable from traditional pyrolysis because it employs an oxidizing agent—i.e., air—to continue combustion of tires. There is no limitation made herein to the method of thermal demanufacturing ELTs, but an illustrative method is described in, inter alia, U.S. Pat. No. 10,703,876.

U.S. Pat. No. 10,119,031B2 to Black Bear Carbon and titled METHOD FOR OBTAINING A CARBON BLACK POWDER BY PYROLYZING SCRAP RUBBER, THE CARBON BLACK THUS OBTAINED AND THE USE THEREOF, which is incorporated by reference herein, discloses a method for recycling scrap rubber comprising the steps of pyrolyzing the scrap rubber to obtain a char material; and milling the char material to obtain a carbon black powder. The pyrolysis is performed in a rotary kiln multiple stages each at specific temperatures to reduce the percentage volatiles in the char material. The milling is carried out by a jet milling using compressed air or steam. The obtained rC is characterized by a particle size distribution of D50<10 μm.

U.S. Pat. No. 12,012,497B2, also to Black Bear Carbon and titled RECOVERED CARBON BLACK AND COMPOSITE MATERIAL COMPPRISING SAID RECOVERED CARBON BLACK, which is incorporated by reference herein, characterizes one embodiment of rC as having an iodine adsorption number, measured according to ASTM D-1510-17 of between 95 g/kg and 160 g/kg.

U.S. Pat. No. 11,441,038 to Bolder Industries and titled METHOD FOR PELLETIZING CARBON BLACK RECLAIMED FROM WASTE TIRES, which is incorporated by reference herein, discloses the steps of thermally depolymerizing rubber segments into a volume of carbonaceous material; comminuting the volume to reduce a diameter of agglomerates within the carbonaceous material; removing agglomerates outside selected diameters; and mixing the remaining material with a binding agent to form pellets of desired diameters. The diameters may be about the same, or they can be a blend of different diameters.

In some embodiments, the rC can be a leftover material obtained from thermally demanufacturing tires. As discussed in U.S. Pat. No. 10,703,876 to PRTI and titled “APPARATUS AND METHOD FOR THERMALLY DEMANUFACTURING TIRES AND OTHER WASTE PRODUCTS”, which is incorporated by reference in its entirety, rC can be isolated from a retort chamber used to produce liquid carbonaceous fuel and gaseous products.

Another example process for converting a carbon-containing feedstock to carbon particles is disclosed in U.S. Pat. No. 12,030,776 to Monolith Materials and titled “SYSTEMS AND METHODS FOR PARTICLE GENERATION”, which is incorporated by reference in its entirety. The method comprises the steps of generating a plasma (e.g., comprising at least about 60% by volume hydrogen) with plasma generating electrodes (e.g., in a reactor), and injecting hydrocarbon (e.g., methane, ethane, unsaturated) to form the carbon particles. In one contemplated embodiment, the hydrocarbon feedstock can be ELT oil obtained from pyrolysis. By adding the hydrocarbon to the hot (e.g., plasma) gas, hydrogen is removed from the hydrocarbon to make the hydrocarbon particles.

The sustainable recovered carbon materials used to produce the elastomer composites described herein can exist in several forms. For example, the carbon material can include, but is not limited to, graphite including pyrolytic graphite, graphene, turbostratic graphene, carbon black (rCB), fibrous carbon, buckminister fullerenes including buckyballs, single wall carbon nanotubes, and multi-wall carbon nanotubes. In one aspect, the carbon material is carbon black manufactured by Black Bear Carbon of the Netherlands. In one aspect, the carbon material is carbon black manufactured by Bolder Industries of Colorado.

There are many versions of recovered carbon material commercially available, particularly because recovered carbon black is an attractive material from a sustainability and circular economy perspective. However, many recovered carbon blacks show detectable levels of crystalline silica. The presence of this impurity may raise environmental health or safety concerns when use of recovered carbon becomes widespread across the industry. Typically, air conveyance, storage, and mixing techniques may present exposure hazards depending on the selected material.

One solution of the disclosure uses recovered carbon in a masterbatch. The pre-blend masterbatch or matrix provides a safe raw material that is amenable to existing manufacturing footprints without creating exposure concerns. The material could be a bale, pellet, paste or slurry.

In one aspect, the elastomer composite is produced by admixing a slurry of an elastomer with a slurry of the carbon material. This process is referred to herein as “liquid processing.” This process is distinguishable over dry mixing, where the elastomer and carbon material are mixed together in dry form. Liquid processing ensures that the carbon material is uniformly dispersed throughout the elastomer such that the concentration of the carbon is equivalent (i.e., ±5%) throughout the elastomer composite.

In one aspect, the elastomer composite is produced by reacting a continuous flow of first fluid comprising the elastomer with a continuous flow of second fluid comprising the carbon material derived from waste tires to form a mixture with the elastomer and produce the elastomer composite. In another aspect, the elastomer composite is produced by the method comprising
(a) feeding a continuous flow of first fluid comprising the elastomer to a reactor comprising a mixing zone and a discharge end;
(b) feeding a continuous flow of second fluid comprising the carbon material derived from waste tires to the mixing zone of the reactor to the elastomer composite, wherein the elastomer composite is passed as a continuous flow to the discharge end; and
(c) discharging the elastomer composite from the discharge end of the reactor.

U.S. Pat. No. 6,048,923, which provides exemplary methods for producing the elastomer composite, is incorporated by reference in its entirety. In one aspect, the elastomer composite is produced by feeding simultaneously the carbon material and an elastomer latex fluid into a mixing zone of a coagulum reactor. A coagulum zone extends from the mixing zone, preferably progressively increasing in cross-sectional area in the downstream direction from an entry end to a discharge end. The particulate filler fluid is fed to the mixing zone preferably as a continuous, high velocity jet of injected fluid, while the latex fluid is fed at low velocity. The velocity, flow rate and particulate concentration of the particulate filler fluid are sufficient to cause mixture with high shear of the latex fluid and flow turbulence of the mixture within at least an upstream portion of the coagulum zone so as to substantially completely coagulate the elastomer latex with the particulate filler prior to the discharge end.

Suitable elastomer latex fluids include both natural and synthetic elastomer latices and latex blends. Exemplary elastomers include, but are not limited to, rubbers, polymers (e.g., homopolymers, copolymers and/or terpolymers) of 1,3-butadiene, styrene, isoprene, isobutylene, 2,3-dimethyl-1,3-butadiene, acrylonitrile, ethylene, and propylene and the like. The elastomer may have a glass transition temperature (Tg) as measured by differential scanning calorimetry (DSC) ranging from about −120 °C to about 0 °C. Examples include, but are not limited to, styrene-butadiene rubber (SBR), natural rubber and its derivatives such as chlorinated rubber, polybutadiene, polyisoprene, poly(styrene-co-butadiene) and the oil extended derivatives of any of them. Blends of any of the foregoing may also be used.

The latex may be in an aqueous carrier liquid. Alternatively, the liquid carrier may be a hydrocarbon solvent. In any event, the elastomer latex fluid must be suitable for controlled continuous feed at appropriate velocity, pressure and concentration into the mixing zone. Particular suitable synthetic rubbers include: copolymers of styrene and butadiene; polymers and copolymers of conjugated dienes such as polybutadiene, polyisoprene, polychloroprene, and the like, and copolymers of such conjugated dienes with an ethylenic group-containing monomer copolymerizable therewith such as styrene, methyl styrene, chlorostyrene, acrylonitrile, 2-vinyl-pyridine, 5-methyl-2-vinylpyridine, 5-ethyl-2-vinylpyridine, 2-methyl-5-vinylpyridine, alkyl-substituted acrylates, vinyl ketone, methyl isopropenyl ketone, methyl vinyl either, alpha methylene carboxylic acids and the esters and amides thereof such as acrylic acid and dialkylacrylic acid amide. Also suitable for use herein are copolymers of ethylene and other high alpha olefins such as propylene, butene-1 and pentene-1.

Where the elastomer is a natural rubber latex, the natural rubber latex can include field latex or latex concentrate (produced, for example, by evaporation, centrifugation or creaming). The latex is provided typically in an aqueous carrier liquid. Alternatively, the liquid carrier may be a hydrocarbon solvent.

The amount of carbon material mixed with the elastomer can vary depending upon the intended use of the elastomer composite. In one aspect, the carbon material is from about 10 phr to about 120 phr of elastomer composite. In another aspect, the carbon material is from about 10 phr, 20 phr, 30 phr, 40 phr, 50 phr, 60 phr, 70 phr, 80 phr, 90 phr, 100 phr, 110 phr, or 120 phr of elastomer composite, where any value can be a lower and upper endpoint of a range (e.g., 50 phr to 80 phr).

The elastomer composite can include one or more additives typically used to produce rubber compositions. In one aspect, the additive can be added to a slurry of the elastomer prior to mixing with the slurry of the carbon material. In another aspect, the additive can be added to a slurry of the carbon material prior to mixing the with the slurry of the elastomer. In another aspect, the additive can be added to a slurry of elastomer and carbon material.

In one aspect, the additive can be silica. In one aspect, the silica can be obtained by the acidification of a soluble silicate, e.g., sodium silicate. In one embodiment, the uncured composition includes about 85 to 95 phr or about 90 phr of the precipitated silica. Conventional silicas can be characterized by a Brunauer-Emmett-Teller (BET) surface area, as measured using nitrogen gas. In one aspect, the BET surface area can be in the range of about 150 m²/g to about 165 m²/g or about 160 m²/g. The BET method of measuring surface area is described in the Journal of the American Chemical Society, Volume 60, Page 304 (1930 ). In one embodiment, the conventional silica can have an average ultimate particle size in the range of about 0.01 μm to about 0.05 μm as determined by an electron microscope. In other embodiments, the silica particles are smaller than 0.01 μm. In other aspects, the silica particles are larger than 0.05 μm.

Exemplary untreated precipitated silicas are available from PPG Industries as Hi-Sil™, e.g., under the designations 210, 243, 315, EZ 160G-D, EZ 150G, 190G, 200G-D, HDP-320G, and 255CG-D; from Solvay as Zeosil™, under the designations 115GR, 125GR, 165GR, 175GR, 185GR, 195GR, 1085GR, 1165MP, 1115MP, HRS 1200MP, Premium MP, Premium 200MP, and 195 HR; from Evonik as Ultrasil™, under the designations VN2, VN3, VN3GR, 5000GR, 7000GR, 9000GR, as Zeopol™, under the designations 8755LS and 8745; from Wuxi Quechen Silicon Chemical Co., Ltd. as Newsil™, under the designations 115GR and 2000MP; from Maruo Calcium Co., Ltd., as Tokusil™ 315, and silicas derived from rice husk ash from Yihai Food and Oil Industry, China. Any precipitated silica can be used in the method. In other embodiments, the untreated precipitated silica is prepared as a wet filtered material shortly before use.

In another aspect, the silica may be pre-hydrophobated (or pre-silanized) precipitated silica. By pre-hydrophobated, it is meant that the silica is pretreated, i.e., the pre-hydrophobated precipitated silica is hydrophobated prior to its addition to the rubber composition by treatment with at least one silane. Suitable silanes include but are not limited to alkylsilanes, alkoxysilanes, organoalkoxysilyl polysulfides and organomercaptoalkoxysilanes. In an alternative embodiment, the pre-hydrophobated precipitated silica may be pre-treated with a silica coupling agent comprised of, for example, an alkoxyorganomercaptoalkoxysilane or combination of alkoxysilane and organomercaptoalkoxysilane prior to blending the pre-treated silica with the rubber instead of reacting the precipitated silica with the silica coupling agent in situ within the rubber. For example, see U.S. Pat. No. 7,214,731. The pre-hydrophobated precipitated silica may optionally be treated with a silica dispersing aid. Such silica dispersing aids may include glycols such as fatty acids, diethylene glycols, polyethylene glycols, fatty acid esters of hydrogenated or non-hydrogenated C5 or C6 sugars, and polyoxyethylene derivatives of fatty acid esters of hydrogenated or non-hydrogenated C5 or C6 sugars. Exemplary fatty acids include stearic acid, palmitic acid and oleic acid. Exemplary fatty acid esters of hydrogenated and non-hydrogenated C5 and C6 sugars (e.g., sorbose, mannose, and arabinose) include, but are not limited to, the sorbitan oleates, such as sorbitan monooleate, dioleate, trioleate and sesquioleate, as well as sorbitan esters of laurate, palmitate and stearate fatty acids. Exemplary polyoxyethylene derivatives of fatty acid esters of hydrogenated and non-hydrogenated C5 and C6 sugars include, but are not limited to, polysorbates and polyoxyethylene sorbitan esters, which are analogous to the fatty acid esters of hydrogenated and non-hydrogenated sugars noted above except that ethylene oxide groups are placed on each of the hydroxyl groups. Optional silica dispersing aids if used are present in an amount ranging from about 0.1% to about 25% by weight based on the weight of the silica, with about 0.5% to about 20% by weight being suitable, and about 1% to about 15% by weight based on the weight of the silica also being suitable. For various pre-treated precipitated silicas see, for example, U.S. Pat. Nos. 4,704,414, 6,123,762, and 6,573,324.

In one aspect, the additive is a plasticizer. In one aspect, the plasticizer is a hydrocarbon resin having a T_{g} greater than 30 °C, preferably greater than 50 °C, and more preferably greater than 60 °C and less than 100 °C, such as hydrocarbon resins described in “Hydrocarbon Resins” by R. Mildenberger, M. Zander and G. Collin (New York, VCH, 1997, ISBN-3-527-28617-9). Representative hydrocarbon resins include for instance coumarone-indene-resins, petroleum resins, terpene resins, alphamethyl styrene resins and mixtures thereof.

Coumarone-indene resins are commercially available in many forms with melting points ranging from 10 °C to 160 °C, preferably from 30 °C to 100 °C as measured by the ball-and-ring method). Coumarone-indene resins as such are well known. Various analysis indicate that such resins are largely polyindene; however, typically contain random polymeric units derived from methyl indene, coumarone, methyl coumarone, styrene and methyl styrene.

Petroleum resins are commercially available with softening points ranging from 10 °C to 120 °C, preferably from 30 °C to 100 °C. Suitable petroleum resins include both aromatic and nonaromatic types. Several types of petroleum resins are available. Some resins have a low degree of unsaturation and high aromatic content, whereas some are highly unsaturated and yet some contain no aromatic structure at all. Differences in the resins are largely due to the olefins in the feedstock from which the resins are derived. Conventional derivatives in such resins include dicyclopentadiene, cyclopentadiene, their dimers and diolefins such as isoprene and piperylene. In one aspect, the hydrocarbon resin is Oppera™ PR383 manufactured by Exxon Mobil, which is a hydrogenated C9 modified dicyclopentadiene having a T_{g} of about 54 °C.

In one aspect, terpene resins can be used as the hydrocarbon resin. Terpene polymers (or resins) may be typically commercially produced from polymerizing alpha or beta pinenes. In particular, alpha pinene based resins may be used. Terpene resins may be supplied in a variety of melting points ranging from 10 °C to 135 °C. The terpene resins may for example have a molecular weight M_{w} of less than 1000 g/mol, preferably less than 950 g/mol or ranging between 200 g/mol and 950 g/mol, as measured by gel permeation chromatography (GPC). An example of an alpha pinene based resin is Dercolyte™ A 115 of the company DRT which has a molecular weight M_{w} of about 900 g/mol.

In one aspect, the hydrocarbon resin is derived from styrene and alphamethylstyrene. The presence of the styrene/alphamethylstyrene resin with a rubber blend which contains the presence of the styrene-butadiene elastomer is considered herein to be beneficial because of observed viscoelastic properties of the tread rubber composition such as complex and storage modulus, loss modulus, tangent delta and loss compliance at different temperature/frequency/strain. The properties of complex and storage modulus, loss modulus, tangent delta and loss compliance are understood to be generally well known to those having skill in such art. The molecular weight distribution of the resin is visualized as a ratio of the resin's molecular weight average (Mw) to molecular weight number average (Mn) values and is considered herein to be in a range of about 1.5/1 to about 2.5/1 which is considered to be a relatively narrow range. This is believed to be advantageous because of the selective compatibility with the polymer matrix and because of a contemplated use of the tire in wet and dry conditions over a wide temperature range. The glass transition temperature Tg of the copolymer resin is considered herein to be in a range of about 20 °C to about 100 °C, alternatively about 50 °C to about 70 °C. A suitable measurement of T_{g} for resins is DSC according to ASTM D6604 or equivalent. The styrene/alphamethylstyrene resin is considered herein to be a copolymer of styrene and alphamethylstyrene with a styrene/alphamethylstyrene molar ratio in a range of about 0.40 to about 1.50. In one aspect, such a resin can be suitably prepared, for example, by cationic copolymerization of styrene and alphamethylstyrene in a hydrocarbon solvent. Thus, the contemplated styrene/alphamethylstyrene resin can be characterized, for example, by its chemical structure, namely, its styrene and alphamethylstyrene contents and softening point and also, if desired, by its glass transition temperature, molecular weight and molecular weight distribution. In one embodiment, the styrene/alphamethylstyrene resin is composed of about 40 to about 70 percent units derived from styrene and, correspondingly, about 60 to about 30 percent units derived from alphamethylstyrene. In one embodiment, the styrene/alphamethylstyrene resin has a softening point according to ASTM No. E-28 in a range of about 80 °C to about 145 °C Suitable styrene/alphamethylstyrene resin is available commercially as Resin 2336 from Eastman or Sylvares SA85 from Arizona Chemical.

In one aspect, the additive is a sulfur donor. Representative examples of sulfur donors include elemental sulfur (free sulfur), an amine disulfide, polymeric polysulfide and sulfur olefin adducts. In one aspect, the sulfur-vulcanizing agent is elemental sulfur. The sulfur donor may for instance be used in an amount ranging from 0.5 phr to 8 phr, alternatively with a range of from 1 phr to 3 phr.

In one aspect, the additive is an antioxidant (also referred to as an antidegradant). Representative antioxidants may be, for example, diphenyl-p-phenylenediamine and others, such as, for example, those disclosed in The Vanderbilt Rubber Handbook (1978), Pages 344 through 346. Typical amounts of antioxidants, if used, may for example include 1 phr to 5 phr.

In one aspect, the additive is an antiozonant. Representative antiozonants include, but are not limited to, N-phenyl-N′-(1,3-dimethylbutyl)-p-phenylenediamine (6PPD) and N,N′-o-tolyl-p-phenylenediamine (DTPD). Typical amounts of antiozonants, if used, may for instance comprise 1 phr to 5 phr. In some aspects, antiozonants are included in amounts of about 1 phr to 5 phr.

In one aspect, the additive is a fatty acid. Typical amounts of fatty acids, if used, which can include stearic acid in an amount of 0.5 phr to 3 phr.

In one aspect, the additive is a wax. Typical amounts of waxes, if used, may include 1 phr to 5 phr.

In one aspect, the additive is zinc oxide. Typical amounts of zinc oxide, if used, may include 1 phr to 5 phr.

In certain aspects, accelerators can be used to control the time and/or temperature required for vulcanization and to improve the properties of the vulcanizate. In one embodiment, a single accelerator system may be used, i.e., primary accelerator. The primary accelerator(s) may be used in total amounts ranging from 0.5 phr to 4 phr, alternatively 0.8 phr to 1.5 phr. In another embodiment, combinations of a primary and a secondary accelerator might be used with the secondary accelerator being used in smaller amounts, such as from 0.05 phr to 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are for instance amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be for instance a guanidine, dithiocarbamate or thiuram compound. Suitable guanidines include dipheynylguanidine and the like. Suitable thiurams include tetramethylthiuram disulfide, tetraethylthiuram disulfide, and tetrabenzylthiuram disulfide.

In one aspect, the additive is an oil. Examples of such oils include, but are not limited to, aromatic, paraffinic, naphthenic, and low PCA oils, such as MES, TDAE, SRAE and heavy naphthenic oils. PCA oils may include those having a polycyclic aromatic content of less than 3 percent by weight as determined by the IP346 method. The oil may be a vegetable oil or vegetable oil derivate (such as sunflower oil, soybean oil or canola oil) or a blend of multiple oils, in particular sunflower oils. Some representative examples of vegetable oils that can be used include soybean oil, sunflower oil, canola (rapeseed) oil, corn oil, coconut oil, cottonseed oil, olive oil, palm oil, peanut oil, and safflower oil.

After the elastomer composite has been prepared, it is vulcanized to produce a vulcanized elastomer composite. In one aspect, vulcanization can be carried out at temperatures ranging from about 100 °C to about 200 °C or 110 °C to about 180 °C. Vulcanization processes can include heating in a press or mold or heating with superheated steam or hot air. The vulcanized elastomer composite can be built, shaped, or molded into any desired shape or article.

In one aspect, the vulcanized elastomer composite is a component of a tire such as, for example, a tread, tire sub-tread, base, sidewall, wire-skim or any combination thereof. In one aspect, the tire may be a radial tire, a pneumatic tire, a non-pneumatic tire, a truck tire and a passenger car tire. The tire may for instance be a winter tire and/or may have a three peak mountain snowflake symbol. Thus, the tire may have a plurality of tread blocks having a plurality of sipes.

The elastomer composites described herein once vulcanized have comparable or improved performance properties when compared to elastomers prepared from traditional fillers and methods. In one aspect, the vulcanized elastomer composites have one or more properties that are comparable or improved when compared to an elastomer composite produced from furnace carbon black such as, for example, N550 or N326. In one aspect, the vulcanized elastomer composite exhibits the compound performance characteristics that are similar to a furnace carbon black, wherein that furnace carbon black has a surface area, as defined by ASTM D6556, at least 15% higher than the furnace black that exhibits performance characteristics that are similar to the dry-mix equivalent compound utilizing the same carbon black derived ELTs as the elastomer composite.

In another aspect, the vulcanized elastomer composites produced from liquid processing as described herein have one or more properties that are comparable or improved when compared to an elastomer composite produced from dry mixing. In one aspect, the vulcanized elastomer composite produced from liquid processing has a Z value that is at least 15% higher than the Z value of the same vulcanized elastomer composite produced by dry processing.

The dispersion of filler in an elastomeric matrix can be represented by the Z value, which is measured, after crosslinking, according to the method described by S. Otto et al. in Kautschuk Gummi Kunststoffe, 58th edition, NR 7-8/2005, in agreement with the standard ISO 11345.

The calculation of the Z value is based on the percentage of surface area in which the filler is not dispersed (“% undispersed surface area”), as measured by the “disperGRADER+” machine provided with its operating process and its “disperDATA” operating software by Dynisco, according to the equation:

Z=100−(% undispersed surface area)/0.35

The percentage of undispersed surface area is, itself, measured by a camera that observes the surface area of the sample under incident light at 30°. The light points are associated with the filler and agglomerates, whilst the dark points are associated with the rubber matrix; digital processing converts the image into a black and white image, and enables the determination of the percentage of undispersed surface area, as described by S. Otto in the aforementioned document.

The higher the Z value, the better the dispersion of the filler in the elastomeric matrix (a Z value of 100 corresponding to a perfect dispersion and a Z value of 0 to a mediocre dispersion). A Z value greater than or equal to 80 will be considered to correspond to a surface area having a very good dispersion of the filler in the elastomeric matrix.

### Aspects

The present disclosure can be described in accordance with the following numbered Aspects, which should not be confused with the claims.
Aspect 1. An elastomer composite comprising a carbon material recovered from end-of-life tires (ELT), the recovered carbon material being uniformly dispersed in an elastomer.
Aspect 2. The elastomer composite of Aspect 1, wherein the recovered carbon material is derived from decomposed ELT.
Aspect 3. The elastomer composite of Aspect 1 or 2, wherein the recovered carbon material is produced by the method comprising: pyrolyzing scrap rubber to obtain a char material; and milling the char material to obtain a carbon black powder.
Aspect 4. The elastomer of Aspect 1 or 3, wherein the recovered carbon material is characterized by a particle size distribution of D50<10 μm.
Aspect 5: The elastomer of Aspect 1-4, wherein the recovered carbon material has an iodine adsorption number, measured according to ASTM D-1510-17 of between 95 g/kg and 160 g/kg.
Aspect 6. The elastomer composite of Aspect 1 or 2, wherein the recovered carbon material is produced by the method comprising
   (a) thermally depolymerizing rubber segments into a volume of carbonaceous material;
   (b) comminuting the volume to reduce a diameter of agglomerates within the carbonaceous material;
   (c) removing agglomerates outside selected diameters; and
   (d) mixing the remaining material with a binding agent to form pellets of a select diameter.
Aspect 7. The elastomer composite of Aspect 1 or 2, wherein the recovered carbon material is isolated from a retort chamber used to produce liquid carbonaceous fuel and gaseous products.
Aspect 8. The elastomer composite of Aspects 1-7, wherein the recovered carbon material comprises a carbon co-product, carbon powder, graphite including pyrolytic graphite, graphene, turbostratic graphene, recovered carbon black (rCB), fibrous carbon, buckminister fullerenes including buckyballs, single wall carbon nanotubes, multi-wall carbon nanotubes, pyrolytic carbon black, or a combination of the above.
Aspect 9. The elastomer composite of any one of Aspects 1-8, wherein the elastomer composite is produced by the method comprising reacting a continuous flow of first fluid comprising the elastomer with a continuous flow of second fluid comprising the carbon material derived from the ELT to form a mixture with the elastomer and produce the elastomer composite.
Aspect 10. The elastomer composite of any one of Aspect 1-9, wherein the elastomer composite is produced by the method comprising
   (a) feeding a continuous flow of first fluid comprising the elastomer to a reactor comprising a mixing zone and a discharge end;
   (b) feeding a continuous flow of second fluid comprising the carbon material derived from the ELT to the mixing zone of the reactor to the elastomer composite, wherein the elastomer composite is passed as a continuous flow to the discharge end; and
   (c) discharging the elastomer composite from the discharge end of the reactor.
Aspect 11. The elastomer composite of Aspect 9 or 10 wherein the carbon material reclaimed from the ELT is mixed with a binding agent prior to admixing with the elastomer.
Aspect 12. The elastomer composite of any one of Aspects 1-12, wherein the elastomer comprises natural rubber, a chlorinated derivative of natural rubber, or a homopolymer, copolymer or terpolymer of butadiene, styrene, isoprene, isobutylene, 2,3-dialkyl-1,3-butadiene where the alkyl group is C1 to C3 alkyl, acrylonitrile, ethylene or propylene.
Aspect 13. The elastomer composite of any one of Aspects 1-12, wherein the method does not comprise admixing an additive with the elastomer and the carbon material derived from the waste tire.
Aspect 14. The elastomer composite of any one of Aspects 1-13, wherein the method further comprises admixing at least one additive with the elastomer and the carbon material reclaimed from waste tires.
Aspect 15. The elastomer composite of Aspect 14, wherein the at least one additive is selected from the group consisting of an antiozonant, an antioxidant, a plasticizer, a processing aid, a resin, a flame retardant, an extender oil, a lubricant, and any combination thereof.
Aspect 16. The elastomer composite of any one of Aspects 1-15, wherein the carbon material reclaimed from waste tires is from about 20 phr to about 120 phr of elastomer composite.
Aspect 17. A vulcanized elastomer composite comprising the elastomer composite of any one of Aspects 1-16 that has been vulcanized.
Aspect 18. The vulcanized elastomer composite of Aspect 17 wherein the vulcanized elastomer composite exhibits one or more performance characteristics that are similar to a furnace carbon black, wherein the furnace carbon black has a surface area as defined by ASTM D6556 that is at least 15% greater than the furnace carbon black that exhibits performance characteristics that are similar to the dry-mix equivalent compound utilizing the same carbon black derived from carbon oxide as the elastomer composite.
Aspect 19. The vulcanized elastomer composite of Aspect 18, wherein when the elastomeric composite is produced by a liquid process, the elastomeric composite has a Z value that is at least 15% greater than the Z value of an elastomeric composite produced by a dry-mix process using the same amount of carbon material derived from a carbon oxide compound.
Aspect 20. An article comprising the vulcanized elastomer composite of Aspect 19.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. An elastomer composite comprising a carbon material recovered from end-of-life tires (ELT), the recovered carbon material being uniformly dispersed in an elastomer.

2. The elastomer composite of claim 1, wherein the recovered carbon material is derived from decomposed ELT.

3. The elastomer composite of claim 2, wherein the recovered carbon material is produced by a method comprising: pyrolyzing scrap rubber to obtain a char material; and milling the char material to obtain a carbon black powder.

4. The elastomer of claim 1, wherein the recovered carbon material is characterized by a particle size distribution of D50<10 μm.

5. The elastomer of claim 1, wherein the recovered carbon material has an iodine adsorption number, measured according to ASTM D-1510-17 of between 95 g/kg and 160 g/kg.

6. The elastomer composite of claim 2, wherein the recovered carbon material is produced by the method comprising
(a) thermally depolymerizing rubber segments into a volume of carbonaceous material;
(b) comminuting the volume to reduce a diameter of agglomerates within the carbonaceous material;
(c) removing agglomerates outside selected diameters; and
(d) mixing the remaining material with a binding agent to form pellets of a select diameter.

7. The elastomer composite of claim 2, wherein the recovered carbon material is isolated from a retort chamber used to produce liquid carbonaceous fuel and gaseous products.

8. The elastomer composite of claim 1, wherein the recovered carbon material comprises a carbon co-product, carbon powder, graphite including pyrolytic graphite, graphene, turbostratic graphene, recovered carbon black (rCB), fibrous carbon, buckminister fullerenes including buckyballs, single wall carbon nanotubes, multi-wall carbon nanotubes, pyrolytic carbon black, or a combination of the above.

9. The elastomer composite of any one of claim 1, wherein the elastomer composite is produced by the method comprising reacting a continuous flow of first fluid comprising the elastomer with a continuous flow of second fluid comprising the carbon material derived from the ELT to form a mixture with the elastomer and produce the elastomer composite.

10. The elastomer composite of any one of claim 1, wherein the elastomer composite is produced by the method comprising
(a) feeding a continuous flow of first fluid comprising the elastomer to a reactor comprising a mixing zone and a discharge end;
(b) feeding a continuous flow of second fluid comprising the carbon material derived from the ELT to the mixing zone of the reactor to the elastomer composite, wherein the elastomer composite is passed as a continuous flow to the discharge end; and
(c) discharging the elastomer composite from the discharge end of the reactor.

11. The elastomer composite of claim 10 wherein the carbon material reclaimed from the ELT is mixed with a binding agent prior to admixing with the elastomer.

12. The elastomer composite of any one of claim 10, wherein the elastomer comprises natural rubber, a chlorinated derivative of natural rubber, or a homopolymer, copolymer or terpolymer of butadiene, styrene, isoprene, isobutylene, 2,3-dialkyl-1,3-butadiene where the alkyl group is C1 to C3 alkyl, acrylonitrile, ethylene or propylene.

13. The elastomer composite of any one of claim 10, wherein the method does not comprise admixing an additive with the elastomer and the reclaimed carbon material.

14. The elastomer composite of any one of claim 10, wherein the method further comprises admixing at least one additive with the elastomer and the carbon material reclaimed from waste tires.

15. The elastomer composite of claim 14, wherein the at least one additive is selected from the group consisting of an antiozonant, an antioxidant, a plasticizer, a processing aid, a resin, a flame retardant, an extender oil, a lubricant, and any combination thereof.

16. The elastomer composite of any one of claim 1, wherein the reclaimed carbon material is from about 20 phr to about 120 phr of elastomer composite.

17. A vulcanized elastomer composite comprising the elastomer composite of any one of Claim 10 that has been vulcanized.

18. The vulcanized elastomer composite of claim 17 wherein the vulcanized elastomer composite exhibits one or more performance characteristics that are similar to a furnace carbon black, wherein the furnace carbon black has a surface area as defined by ASTM D6556 that is at least 15% greater than the furnace carbon black that exhibits performance characteristics that are similar to the dry-mix equivalent compound utilizing the same carbon black derived from carbon oxide as the elastomer composite.

19. The vulcanized elastomer composite of claim 18, wherein when the elastomeric composite is produced by a liquid process, the elastomeric composite has a Z value that is at least 15% greater than the Z value of an elastomeric composite produced by a dry-mix process using the same amount of carbon material derived from a carbon oxide compound.

20. An article comprising the vulcanized elastomer composite of claim 19.
